(19) United States
(12) Patent Application Publication
(10) Pub. No.: US 2007/0273328 A1
(43) Pub. Date: Nov. 29, 2007

(54) BATTERY PACK

(76) Inventors: Kwangwoo Nam, Yongin-si (KR); Testuya Okada, Yongin-si (KR)

Correspondence Address: CHRISTIE, PARKER & HALE, LLP, PO BOX 7068, PASADENA, CA, 91109-7068, US

(21) Appl. No.: 11/751,583

(22) Filed: May 21, 2007

(30) Foreign Application Priority Data
May 24, 2006 (KR) 10-2006-0046744

(51) Int. Cl. H02J 7/00

(52) U.S. Cl. 320/112

(57) ABSTRACT

A battery pack adapted to automatically intercept a charge and discharge path when the temperature of a battery increases to no less than a reference temperature during a charging and/or discharging of the battery to improve stability and reliability. The battery pack includes at least one rechargeable battery; at least one posistor located on one side of the battery and connected to the battery in parallel at substantially a same time and having a resistance value which increases when the temperature of the battery increases; a first switch having one end connected to the posistor and configured to be applied with a driving voltage when the resistance value of the posistor increases; and a second switch connected to a charge and discharge path of the battery and connected to the first switch at substantially a same time to intercept the charge and discharge path when the first switch operates.

### CROSS-REFERENCE TO RELATED APPLICATION

This application claims priority to and the benefit of Korean Patent Application No. 10-2006-0046744, filed on May 24, 2006, in the Korean Intellectual Property Office, the entire content of which is incorporated herein by reference.

### BACKGROUND OF THE INVENTION

1. Field of the invention

The present invention relates to a battery pack.

2. Description of the Prior Art

In general, a battery pack can be categorized into a soft pack, in which a protective circuit is mounted on a battery and provided in a tubing, and a hard pack, in which a protective circuit is mounted on a battery and included in a hard case. Also, the form in which only the protective circuit is mounted on the battery can be referred to as a core pack. However, hereinafter, the soft pack, the hard pack, and the core pack are referred to as the battery pack. In addition, the form in which the protective circuit is not mounted on the battery is referred to as a bare cell.

Also, the battery used for the battery pack is divided into a polygon type battery, a pouch type battery, and a cylinder type battery. One polygon type or pouch type battery can be used for the battery pack of a very small electronic apparatus such as a mobile telephone or a personal digital assistant (PDA). A plurality of cylinder type batteries are connected to each other in serial and in parallel to be used for the battery pack of an electronic apparatus that requires large capacity, such as a notebook.

A rechargeable battery such as a Ni—Cd battery, a Ni-MH battery, a Li-ion battery, or a Li-polymer battery can be used as the battery for the battery pack. Recently, a lithium based battery that has a relatively high energy density and a relatively large capacity and that is relatively light has been used as the rechargeable battery.

There is a chance of overheating and exploding when the lithium based battery is overcharged and/or a chance of damaging the battery when the lithium based battery is over-discharged. Therefore, in order to prevent (or protect) the lithium based battery from being overcharged and/or over-discharged, as described above, the protective circuit is mounted on the battery. The protective circuit protects the battery by automatically stopping the charge and discharge of the battery when the battery is being overcharged and/or over-discharged and/or when the battery is being applied with an over-current and/or has an external short

The conventional protective circuit sufficiently protects the battery from being overcharged, over-discharged, and/or from having the external short; however, it does not sufficiently protect the battery or the battery pack from being overheated.

The battery pack is commonly overheated when it is overcharged and/or over-discharged so that the protective circuit senses an overcharge and/or over-discharge voltage to intercept (and/or block) the charge and discharge path. However, when the protective circuit is out of order, such a function may not be performed. Therefore, when the protective circuit does not operate, the temperature of the battery pack may increase to a degree that may not be controlled.

When the temperature of the battery continuously increases, an internal pressure in the battery increases. The increased internal pressure damages the battery and may cause an explosion and/or fire and/or may damage the charger and/or the external load coupled with the battery pack.

### SUMMARY OF THE INVENTION

Aspects according to embodiments of the present invention are directed to a battery pack in which a charge and discharge path of the battery pack is automatically intercepted when a temperature of a battery of the battery pack increases to be equal to or greater than a reference temperature to improve stability and reliability of the battery pack.

An embodiment of the present invention provides a battery pack including: at least one rechargeable battery; at least one posistor located on one side of the battery and connected to the battery in parallel and having a resistance value which increases when the temperature of the battery increases; a first switch having one end connected to the posistor and configured to be applied with a driving voltage when the resistance value of the posistor increases; and a second switch connected to a charge and discharge path of the battery and connected to the first switch to intercept the charge and discharge path when the first switch operates.

In one embodiment, the battery comprises a battery selected from the group consisting of a Ni—Cd battery, a Ni-MH battery, a sealed up lead-acid battery, a Li-ion battery, a Li-polymer battery, and combinations thereof.

In one embodiment, the posistor includes a positive temperature coefficient thermistor whose resistance value increases in accordance with an increase in the temperature of the battery.

In one embodiment, a reference resistor is connected to the charge and discharge path between the battery and the second switch, and the reference resistor is connected between the posistor and the first switch. Here, the resistance value of the reference resistor may be between 1MΩ and 10MΩ.

In one embodiment, the resistance value of the posistor ranges from about 10 Ω to about 900 Ω at a temperature between 0° C. and 30° C. and ranges from about 900 Ω to about 10MΩ at a temperature between 30° C. and 150° C.

In one embodiment, the first switch includes a field effect transistor (FET).

In one embodiment, the first switch includes an N channel FET.

In one embodiment, the second switch includes: at least one fuse serially connected to the charge and discharge path; and a heating resistor having one end connected to the fuse and another end connected to the first switch.

In one embodiment, when the battery is being charged, the resistance value of the posistor increases when the temperature of the battery increases, and, when the resistance value of the posistor increases, the first switch is turned on so that a charge current flows along a path of a pack positive electrode of the battery pack, the second switch, the first switch, and a negative electrode of the battery pack and that the second switch cuts off the charge and discharge path.

In one embodiment, when the battery is being discharged, the resistance value of the posistor increases when the temperature of the battery increases, and, when the resistance value of the posistor increases, the first switch is turned on so that discharge current flows along a path of a positive electrode of the battery, the second switch, the first switch, and a negative electrode of the battery and that the second switch cuts off the charge and discharge path.

In one embodiment, the battery includes a plurality of batteries serially connected to each other, the posistor includes a plurality of posistors located on one side of the batteries, and the plurality of posistors are serially connected to each other.

In one embodiment, the second switch includes: at least two fuses serially connected to each other and the charge and discharge path; and a heating resistor having one end connected between the two fuses and another end connected to the first switch.

Another embodiment of the present invention provides a battery pack including: at least one rechargeable battery; at least one posistor located on one side of the battery and connected to the battery in parallel and having a resistance value which increases when the temperature of the battery increases; a first switch having one end connected to the posistor and configured to be turned on when the resistance value of the posistor is not less than a value corresponding to a reference temperature; and a second switch connected to a charge and discharge path of the battery and the first switch to intercept the charge and discharge path when the first switch is turned on.

As described above, in an battery pack according to an embodiment of the present invention, when the temperature of a battery increases due to an overcharge, an over-discharge, an over-current, or an external short, this temperature increase is sensed by a posistor to generate a driving voltage and to sequentially operate a first switch and a second switch so that the second switch cuts off from a charge and discharge path.

Therefore, according to the present invention, when the temperature of the battery pack increases to be greater than (or equal to) an allowed range, the charge and discharge path is automatically intercepted so that it is possible to improve the stability and reliability of the battery pack.

Furthermore, according to the present invention, since the number of circuit elements for protecting the battery pack is reduced (or minimized), it is possible to prevent (or protect) the battery pack from having a battery that is overcharged, and/or has an over-current, and/or an external short.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic circuit diagram illustrating a battery pack according to an embodiment of the present invention;

FIGS. 2A and 2B are schematic circuit diagrams illustrating protective operations during charge and discharge in the circuit diagram illustrated in FIG. 1;

FIG. 3 is a schematic circuit diagram illustrating a battery pack according to another embodiment of the present invention; and

FIGS. 4A and 4B are schematic circuit diagrams illustrating protective operations during charge and discharge in the circuit diagram illustrated in FIG. 3.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

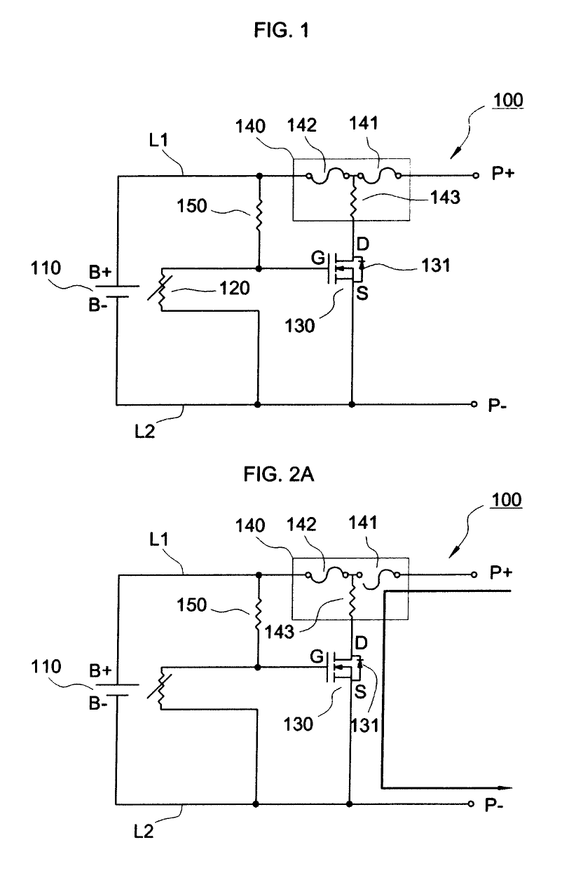

FIG. 1 is a schematic circuit diagram illustrating a battery pack according to an embodiment of the present invention.

As illustrated in FIG. 1, a battery pack 100 according to an embodiment of the present invention includes a rechargeable battery 110, a posistor 120 positioned on one side of the battery 110, a first switch 130 connected to one end of the posistor 120, and a second switch 140 connected to one end of the first switch 130.

A positive electrode terminal B+ is provided in the battery 110, and the second switch 140 and a pack positive electrode terminal P+ are connected to the positive electrode terminal B+ through a charge and discharge path L1. In addition, a negative electrode terminal B− is provided in the battery 110, and a pack negative electrode terminal P− is connected to the negative electrode terminal B− through a charge and discharge path L2. Furthermore, a reference resistor 150 is connected between the charge and discharge path L1 and the posistor 120 and between the charge and discharge path L1 and the first switch 130. Such a structure will be described in more detail below.

The battery 110 can be a common rechargeable Ni—Cd, Ni-MH, sealed up lead-acid, Li-ion, Li-polymer, or equivalent battery. However, the kind of the rechargeable battery 110 is not limited to the described batteries.

The posistor 120 is positioned to be close or attached to the battery 110 so as to rapidly react with the temperature of the battery 110. One end of the posistor 120 is connected to the charge and discharge path L2 connected to the negative electrode terminal B− and the other end of the posistor 120 is connected to the reference resistor 150 and the first switch 130. The posistor 120 can be a positive temperature coefficient thermistor whose resistance value increases when the temperature of the battery 110 increases or an equivalent. However, the kind of the posistor 120 is not limited to the described posistor(s). Furthermore, in one embodiment, the resistance value of the posistor 120 can range from several tens to several hundreds Ω at room temperature; however, the resistance may increase from several tens Ω to several MΩ when the temperature of the battery 110 increases. In one embodiment, the resistance value of the posistor 120 ranges from about 10 Ω to 900 Ω at a temperature that ranges from 0° C. and 30° C.; however, the resistance value of the posistor 120 can increase to be between 900 Ω to 10MΩ at a temperature between 30° C. and 150° C. On the other hand, the resistance value of the reference resistor 150 connected with the charge and discharge path L1 connected to the positive electrode terminal B+ of the battery 110, with the posistor 120, and with the first switch 130 can be set to be from about 1 MΩ to 10MΩ. However, the resistance values of the posistor 120 and the reference resistor 150 can vary in accordance with the voltage of the battery 110 and the driving voltage of the first switch 130. As such, the present invention is not limited to the above-described resistance values.

The first switch 130 is connected to the posistor 120 and one end of the reference resistor 150. The one end of the reference resistor 150 is connected to the charge and discharge path L2 connected to the negative electrode terminal B− of the battery 110. The other end of the reference resistor 150 is connected to the second switch 140. A bipolar transistor, a field effect transistor (FET), or an equivalent can be used as the first switch 130. However, the kind of the first switch 130 is not limited to the above. In the drawing, an N channel FET is used as the first switch 130. In more detail, the gate G of the first switch 130 is connected to the reference resistor 150 and the posistor 120. The source S of the first switch 130 is connected to the charge and discharge path L2 connected to the negative electrode terminal B− of the battery 110. The drain D of the first switch 130 is connected to the second switch 140. A parasite diode or a body diode 131 is connected between the source S and the drain D of the first switch 130, that is, the N channel FET.

The second switch 140 is serially connected to the charge and discharge path L1 connected to the positive electrode terminal B+ of the battery 110. That is, the second switch 140 is serially connected between the reference resistor 150 and the pack positive electrode terminal P+. The second switch 140 can be composed of two fuses 141 and 142 serially connected to each other and a heating resistor 143 connected between the fuses 141 and 142. One end of the heating resistor 143 is connected to the first switch 130. That is, the one end of the heating resistor 143 is connected to the drain D of the N channel FET.

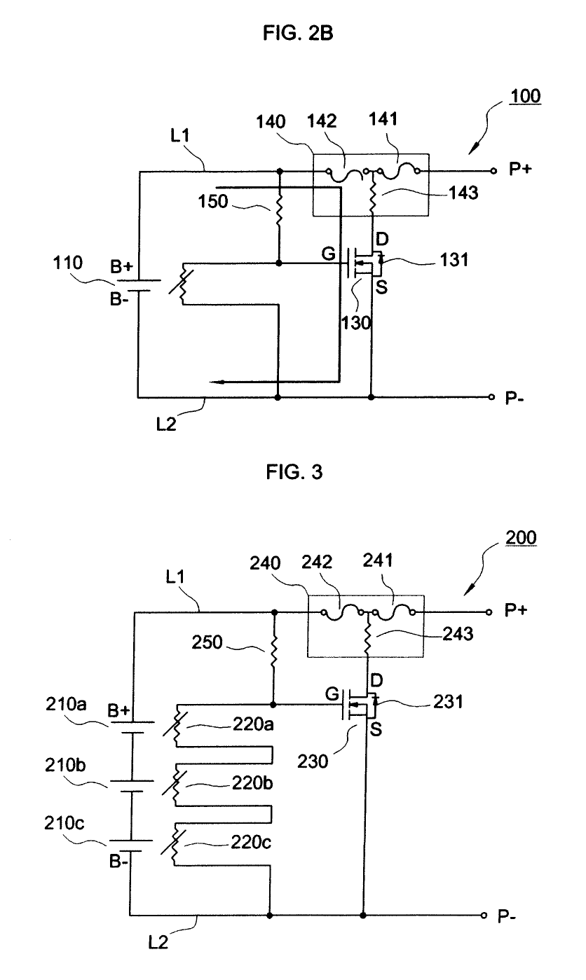

FIGS. 2A and 2B are schematic circuit diagrams illustrating protective operations during charge and discharge in the circuit diagram illustrated in FIG. 1.

FIG. 2A illustrates a state when the battery pack 100 is connected to a charger, and when the second switch is opened (or cut off) due to an increase of the temperature of the battery 110 by an overcharge voltage or overcharge current.

As described above, when the battery 110 is overcharged so that the temperature of the battery 110 increases, the temperature of the posistor 120 also increases.

Then, the resistance value of the posistor 120 increases from several tens Ω to several MΩ.

Therefore, a voltage to the degree by which the first switch 130 operates is applied to the first switch 130 connected between the reference resistor 150 and the posistor 120. By contrast when the temperature of the battery 110 is relatively low, the resistance value of the posistor 120 is low, and the voltage to the degree by which the first switch 130 operates is not applied to the first switch 130.

When the operation voltage is applied to the first switch 130, as described above, the first switch 130 is turned on. That is, in the case where the first switch 130 is the N channel FET, when the operation voltage is applied to the gate G of the N channel FET, the channel is opened and electricity flows through the source S and the drain D.

Therefore, the charge current flows through the pack positive electrode terminal P+ of the battery pack 100, the one fuse 141 of the second switch 140, the heating resistor 143 of the second switch 140, the first switch 130, and the pack negative electrode terminal P− of the battery pack 100. That is, the charge current that flowed through the positive electrode terminal B+ of the battery 110 passes through the second switch 140 and the first switch 130.

Thus, the heating resistor 143 of the second switch 140 generates heat so that one of the two fuses 141 and 142 is opened (or cut off) by the heat of the heating resistor 143. In the drawing, the right fuse 141 is cut off. The left fuse 142 can be first cut off. However, since the current from the charger continuously flows through the right fuse 141 and the heating resistor 143 in such a state, as a result, the right fuse 141 is cut off.

Therefore, the charge and discharge path L1 formed between the positive electrode terminal B+ of the battery 110 and the pack positive electrode terminal P+ of the battery pack 100 is intercepted (or blocked or cut off) so that the charging operation is stopped. Thus, the overcharge voltage and the overcharge current are no longer supplied to the battery 110 so that the battery 110 is protected against the overcharge (or overcharge state), and the temperature of the battery 110 does not increase anymore.

Furthermore, the charge current generated by the charger does not flow anymore since the right fuse 141 of the second switch 140 is cut off so that the charger is protected.

Next, FIG. 2B illustrates a state when the battery pack 100 is connected to an external load, and when the second switch is opened (or cut off) due to an increase of the temperature of the battery 110 by an over-discharge voltage, over-discharge current, or external short.

As described above, when the battery 110 is over-discharged so that the temperature of the battery 110 increases, the temperature of the posistor 120 also increases.

Then, the resistance value of the posistor 120 increases from several tens Ω to several MΩ.

Therefore, a voltage to the degree by which the first switch 130 operates is applied to the first switch 130 connected between the reference resistor 150 and the posistor 120. By contrast, when the temperature of the battery 110 is relatively low, the resistance value of the posistor 120 is low, and the voltage to the degree by which the first switch 130 operates is not applied to the first switch 130.

When the operation voltage is applied to the first switch 130, as described above, the first switch 130 is turned on. That is, in the case where the first switch 130 is the N channel FET, when the operation voltage is applied to the gate G of the N channel EFT, the channel is opened and electricity flows through the source S and the drain D.

Therefore, the discharge current flows through the positive electrode terminal B+ of the battery 110, the one fuse 142 of the second switch 140, the heating resistor 143 of the second switch 140, the first switch 130, and the negative electrode terminal B− of the battery 110. That is, the discharge current that flowed through the pack positive electrode terminal P+ of the battery pack 100 passes through the second switch 140 and the first switch 130.

Thus, the heating resistor 143 of the second switch 140 generates heat so that one of the two fuses 141 and 142 is cut off by the heat of the heating resistor 143. In the drawing, the left fuse 142 is cut off. The right fuse 141 can be first cut off. However, since the current from the battery 110 continuously flows through the left fuse 142 and the heating resistor 143 in such a state, as a result, the left fuse 142 is cut off.

Therefore, the charge and discharge path L1 formed between the positive electrode terminal B+ of the battery 110 and the pack positive electrode terminal P+ of the battery pack 100 is intercepted so that the discharging operation is stopped. Thus, the over-discharge from the battery 110 is stopped so that the battery 110 is protected against the over-discharge, and the temperature of the battery 110 does not increase anymore.

The discharge current of the battery 110 does not flow anymore since the left fuse 142 of the second switch 140 is cut off so that the battery 110 is protected.

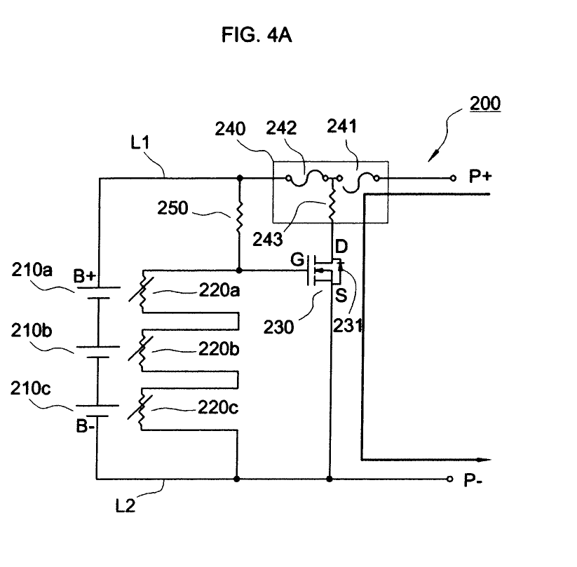

FIG. 3 is a schematic circuit diagram illustrating a battery pack according to another embodiment of the present invention.

As illustrated in FIG. 3, a battery pack 200 according to another embodiment of the present invention is similar (or substantially the same) to the above-described battery pack 100 except for the number of batteries and the number of posistors that are in the battery pack 200. Therefore, a difference between the battery pack 100 and the battery pack 200 will be described below in more detail.

In FIG. 3, the battery pack 200 includes a first battery 210a, a second battery 210b, and a third battery 210c that can be serially connected to each other. The number of batteries is not limited, but no more than or no less than three batteries can be connected to each other. That is, more batteries can be connected to the above batteries in parallel, respectively.

Furthermore, a first posistor 220a, a second posistor 220b, and a third posistor 220c can be positioned on one side of the first battery 210a, one side of the second battery 210b, and one side of the third battery 210c, respectively. The first posistor 220a, the second posistor 220b, and the third posistor 220c can be serially connected to each other. Furthermore, one end of the first posistor 220a is connected to a reference resistor 250 and a first switch 230, and one end of the third posistor 220c is connected to the charge and discharge path L2 connected to the negative electrode terminal B− of the third battery 210c.

Thus, according to the embodiment of FIG. 3, when the temperature of one of the first battery 210a, the second battery 210b, or the third battery 210c increases due to an overcharge or an over-discharge, the resistance value of one of the first posistor 220a, the second posistor 220b, or the third posistor 220c corresponding to the first battery 210a, the second battery 210b, or the third battery 210c increases.

When the resistance value of the one of the first posistor 220a, the second posistor 220b, or the third posistor 220c increases, the first switch 230 is driven so that the second switch 240 is driven together with the first switch 230 and that the charge and discharge path L1 is intercepted (or blocked).

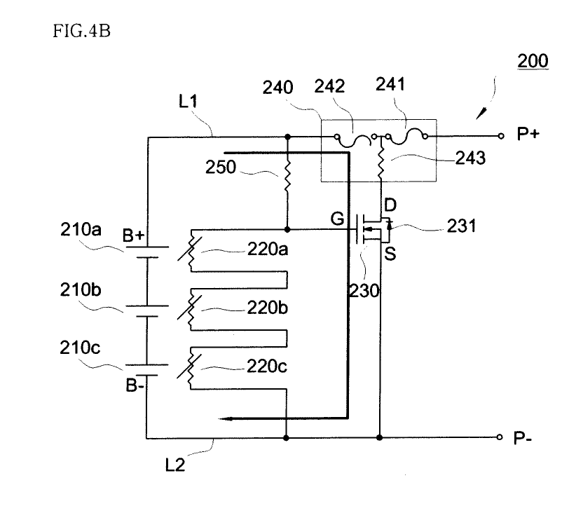

FIGS. 4A and 4B are schematic circuit diagrams illustrating protective operations during charge and discharge in the circuit diagram illustrated in FIG. 3.

FIG. 4A illustrates a state when the battery pack 200 is connected to a charger, and when second switch is opened (or cut off) due to an increase of the temperature of one of the first battery 210a, the second battery 210b, or the third battery 210c by an overcharge voltage or overcharge current.

As described above, when one of the first battery 210a, the second battery 210b, or the third battery 210c is overcharged so that the temperature of the battery increases, the temperature of one of the first posistor 220a, the second posistor 220b, or the third posistor 220c corresponding to the overcharged battery also increases.

Then, the composition resistance value of the first posistor 220a to the third posistor 220c increases from several tens Ω to several MΩ.

Therefore, a voltage to the degree by which the first switch 230 operates is applied to the first switch 230 connected between the reference resistor 250 and the first posistor 220a. By contrast, when the temperature of the battery is relatively low, the composition resistance value of the first posistor 220a, the second posistor 220b, and the third posistor 220c is low, and the voltage to the degree by which the first switch 230 operates is not applied to the first switch 230.

When the operation voltage is applied to the first switch 230, as described above, the first switch 230 is turned on. That is, in the case where the first switch 230 is the N channel FET, when the operation voltage is applied to the gate G of the N channel EFT, the channel is opened and electricity flows through the source S and the drain D.

Therefore, the charge current flows through the pack positive electrode terminal P+ of the battery pack 200, the one fuse 141 of the second switch 240, the heating resistor 243 of the second switch 240, the second switch 240, and the pack negative electrode terminal P− of the battery pack 200. That is, the charge current that flowed through the positive electrode terminal B+ of the first battery 210a passes through the second switch 240 and the first switch 230.

Thus, the heating resistor 243 of the second switch 240 generates heat so that one of the two fuses 241 and 242 is opened (or cut off) by the heat of the heating resistor 243. In the drawing, the right fuse 241 is cut off.

Therefore, the charge and discharge path L1 formed between the positive electrode terminal B+ of the first battery 210a and the pack positive electrode terminal P+ of the battery pack 200 is intercepted so that the charging operation is stopped. Thus, the overcharge voltage and the overcharge current are no longer supplied to the first battery 210a (and/or second battery 210b, and/or third battery 210c) so that the first battery 210a (and/or second battery 210b, and/or third battery 210c) is protected against the overcharge state, and the temperature of the first battery 210a (and/or second battery 210b, and/or third battery 210c) does not increase anymore.

Furthermore, the charge current generated by the charger does not flow anymore since the right fuse 241 of the second switch 240 is cut off so that the charger is protected.

Next, FIG. 4B illustrates a state where the battery pack 200 is connected to an external load, and when the second switch is opened (or cut off) due to an increase of the temperature of one of the first battery 210a, the second battery 210b, or the third battery 210c (to be not less than (or equal to or greater than) a reference temperature) by an over-discharge voltage, over-discharge current, or external short.

As described above, when one of the first battery 210a, the second battery 210b, or the third battery 210c is over-discharged so that the temperature of one of the first battery 210a, the second battery 210b, or the third battery 210c increases, the temperature of one of the first posistor 220a, the second posistor 220b, or the third posistor 220c corresponding to the over-discharged battery also increases.

Then, the composition resistance value of the first posistor 220a to the third posistor 220c increases from several tens Ω to several MΩ.

Therefore, a voltage to the degree by which the first switch 230 operates is applied to the first switch 230 connected between the reference resistor 250 and the first posistor 220a. By contrast, when the temperature of the battery is relatively low, the composition resistance value of the first posistor 220a, the second posistor 220b, and the third posistor 220c is low, and the voltage to the degree by which the first switch 230 operates is not applied to the first switch 230.

When the operation voltage is applied to the first switch 230, as described above, the first switch 230 is turned on. That is, in the case where the first switch 230 is the N channel FET, when the operation voltage is applied to the gate G of the N channel EFT, the channel is opened and electricity flows through the source S and the drain D.

Therefore, the discharge current flows through the positive electrode terminal B+ of the first battery 210a, the one fuse 242 of the second switch 240, the heating resistor 243 of the second switch 240, the second switch 230, and the negative electrode terminal B− of the third battery 210c. That is, the discharge current that flowed through the pack positive electrode terminal P+ of the battery pack 200 passes through the second switch 240 and the first switch 230.

Thus, the heating resistor 243 of the second switch 240 generates heat so that one of the two fuses 241 and 242 is cut off by the heat of the heating resistor 243. In the drawing, the left fuse 242 is cut off.

Therefore, the charge and discharge path L1 formed between the positive electrode terminal B+ of the first battery 210a and the pack positive electrode terminal P+ of the battery pack 200 is intercepted so that the discharging operation is stopped. Thus, the over-discharge voltage, the over-discharge current, and the external short are canceled (or blocked) so that the battery is protected against the over-discharge state, and the temperature of the battery does not increase anymore.

Furthermore, the left fuse 242 of the second switch 240 is cut off so that the discharge current of the battery does not flow anymore and that the battery is protected.

As described above, in a battery pack according to embodiments of the present invention, when the temperature of a battery increases due to an overcharge, an over-discharge, an over-current, and/or an external short, it is sensed by a posistor to generate a driving voltage and to sequentially operate a first switch and a second switch so that the second switch is cut off (or opened or blocked off) from the charge and discharge path.

Therefore, according to the embodiments of the present invention, when the temperature of the battery pack increases to be equal to or greater than an allowed range, the charge and discharge path is automatically intercepted so that it is possible to improve the stability and reliability of the battery pack.

Furthermore, according to embodiments of the present invention, since the number of circuit elements for protecting the battery pack is minimized (or reduced), it is possible to prevent the battery pack from the hazard of having a battery that is overcharged, and/or applied with an over-current, and/or externally shorted.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery pack comprising:
at least one rechargeable battery;
at least one posistor located on one side of the battery and connected to the battery in parallel and having a resistance value which increases when the temperature of the battery increases;
a first switch having one end connected to the posistor and configured to be applied with a driving voltage when the resistance value of the posistor increases; and
a second switch connected to a charge and discharge path of the battery and connected to the first switch to intercept the charge and discharge path when the first switch operates.

2. The battery pack as claimed in claim 1, wherein the battery comprises a battery selected from the group consisting of a Ni—Cd battery, a Ni-MH battery, a sealed up lead-acid battery, a Li-ion battery, a Li-polymer battery, and combinations thereof.

3. The battery pack as claimed in claim 1,
wherein the posistor comprises a positive temperature coefficient thermistor whose resistance value increases in accordance with an increase in the temperature of the battery.

4. The battery pack as claimed in claim 1,
wherein a reference resistor is connected to the charge and discharge path between the battery and the second switch, and
wherein the reference resistor is connected between the posistor and the first switch.

5. The battery pack as claimed in claim 4, wherein the resistance value of the reference resistor is between 1MΩ and 10MΩ.

6. The battery pack as claimed in claim 1, wherein the resistance value of the posistor ranges from about 10Ω to about 900 Ω at a temperature between 0° C. and 30° C. and ranges from about 900 Ω to about 10MΩ at a temperature between 30° C. and 150° C.

7. The battery pack as claimed in claim 1, wherein the first switch comprises a field effect transistor (FET).

8. The battery pack as claimed in claim 1, wherein the first switch comprises an N channel FET.

9. The battery pack as claimed in claim 1, wherein the second switch comprises:
at least one fuse serially connected to the charge and discharge path; and
a heating resistor having one end connected to the fuse and another end connected to the first switch.

10. The battery pack as claimed in claim 1,
wherein, when the battery is being charged, the resistance value of the posistor increases when the temperature of the battery increases,
wherein, when the resistance value of the posistor increases, the first switch is turned on so that a charge current flows along a path of a pack positive electrode of the battery pack, the second switch, the first switch, and a negative electrode of the battery pack and that the second switch cuts off the charge and discharge path.

11. The battery pack as claimed in claim 1,
wherein, when the battery is being discharged, the resistance value of the posistor increases when the temperature of the battery increases, and
wherein, when the resistance value of the posistor increases, the first switch is turned on so that discharge current flows along a path of a positive electrode of the battery, the second switch, the first switch, and a negative electrode of the battery and that the second switch cuts off the charge and discharge path.

12. The battery pack as claimed in claim 1,
wherein the battery comprises a plurality of batteries serially connected to each other,
wherein the posistor comprises a plurality of posistors located on one side of the batteries, and
wherein the plurality of posistors are serially connected to each other.

13. The battery pack as claimed in claim 1, wherein the second switch comprises:
at least two fuses serially connected to each other and the charge and discharge path; and
a heating resistor having one end connected between the two fuses and another end connected to the first switch.

14. A battery pack comprising:
at least one rechargeable battery;
at least one posistor located on one side of the battery and connected to the battery in parallel and having a resistance value which increases when the temperature of the battery increases;
a first switch having one end connected to the posistor and configured to be turned on when the resistance value of the posistor is not less than a value corresponding to a reference temperature; and
a second switch connected to a charge and discharge path of the battery and the first switch to intercept the charge and discharge path when the first switch is turned on.

15. The battery pack as claimed in claim 14,
wherein a reference resistor is connected to the charge and discharge path between the battery and the second switch, and
wherein the reference resistor is connected between the posistor and the first switch.

16. The battery pack as claimed in claim 14, wherein the second switch comprises:
at least one fuse serially connected to the charge and discharge path; and
a heating resistor having one end connected to the fuse and another end connected to the first switch.

17. The battery pack as claimed in claim 14, wherein the second switch comprises:
at least two fuses serially connected to each other and the charge and discharge path; and
a heating resistor having one end connected between the two fuses and another end connected to the first switch.

18. The battery pack as claimed in claim 14,
wherein, when the battery is being charged, the resistance value of the posistor increases when the temperature of the battery increases,
wherein, when the resistance value of the posistor increases, the first switch is turned on so that a charge current flows along a path of a pack positive electrode of the battery pack, the second switch, the first switch, and a negative electrode of the battery pack and that the second switch cuts off the charge and discharge path.

19. The battery pack as claimed in claim 14,
wherein, when the battery is being discharged, the resistance value of the posistor increases when the temperature of the battery increases, and
wherein, when the resistance value of the posistor increases, the first switch is turned on so that discharge current flows along a path of a positive electrode of the battery, the second switch, the first switch, and a negative electrode of the battery and that the second switch cuts off the charge and discharge path.

20. The battery pack as claimed in claim 14,
wherein the battery comprises a plurality of batteries serially connected to each other,
wherein the posistor comprises a plurality of posistors located on one side of the batteries, and
wherein the plurality of posistors are serially connected to each other.
